(19) United States
(12) Patent Application Publication
(10) Pub. No.: US 2014/0336883 A1
(43) Pub. Date: Nov. 13, 2014

(54) DETERMINING THE RELATIVE ORIENTATION OF MEMBERS OF AN ARTICULATED WORK MACHINE

(71) Applicant: CATERPILLAR SARL, Geneva (CH)

(72) Inventors: Stephen Thompson, Sunderland (GB); Gerard Owen McCann, Dunlap, IL (US); David Brion Higdon, East Peoria, IL (US)

(21) Appl. No.: 14/361,773

(22) PCT Filed: Oct. 26, 2012
(86) PCT No.: PCT/GB2012/000801

§ 371 Date: May 30, 2014

(30) Foreign Application Priority Data
Dec. 2, 2011 (GB) 1120766.9

(51) Int. Cl. B60P 1/04; B60P 1/16

(52) U.S. Cl. CPC B60P 1/04; B60P 1/16
USPC 701/50; 701/34.2; 701/33.9; 701/33.4; 701/33.7; 298/22 C

(57) ABSTRACT

An articulated work machine determines the relative orientation of two members of the machine utilizing output from inertia sensors mounted on the members. The machine includes a first frame and a second frame having a body and a chassis, the body pivotally connected to the chassis at a pivot point. The first and second frames are connected by a coupling and are movable relative to each other in at least one direction. The machine includes a first multi-axis inertia sensor attached to the first frame providing an output relating to the position of the first frame, and a second multi-axis inertia sensor attached to the body providing an output relating to the position of the body. The machine further includes a controller configured to compare the outputs of the first and second multi-axis inertia sensors to calculate the position of the body and the first frame relative to each other.

### TECHNICAL FIELD

This disclosure is directed towards determining the relative orientation of two members of an articulated work machine utilising inertia sensors by referencing the output from inertia sensors mounted on the members to one another.

### BACKGROUND

Articulated work machines, including articulated trucks with bodies, articulated trucks with ejector mechanisms, articulated wheel loaders and the like, typically comprise a first frame (such as a tractor) and a second frame (such as a trailer) connected to one another via an articulation joint. The articulation joint enables the frames to roll and yaw relative to one another. Articulated work machines are commonly employed during construction and excavation and may be operated on uneven terrain. As a result, one of the frames may be positioned at an unsafe roll and/or yaw angle and may cause the entire machine to turn over. Alternatively, if the articulated machine has an open container, such as a bucket or body mounted on one of the frames, any materials held in the open container may fall out when one of the frames is positioned above certain roll and/or yaw angle thresholds.

Furthermore, since the roll and yaw angles of one frame are independent of the other frame, the operator may be unaware of the angles at which the frame in which he/she is not located are orientated. The operator may, therefore, be unaware that part of the articulated vehicle is at an unsafe roll and/or yaw angle or may have tipped over.

In many articulated vehicles one of the frames, usually the trailer, may have a body which is movable relative to the frame. One example is a tipping body which can be raised off the trailer chassis to tip out the contents. Currently a switch signal is used to warn the operator that the body is raised off the trailer chassis and provides the operator with information regarding the number of body raise cycles per predefined time interval, e.g. a working shift. With the current arrangement the angle of the body cannot be determined.

One method of preventing tip over of an articulated vehicle is to measure the angle of the vehicle and provide a warning to the operator when the roll and/or yaw angles of the vehicle are approaching unsafe threshold values, above which the vehicle will tip over. U.S. Pat. No. 5,825,284 discloses one such method. The vehicle described therein comprises a tractor and a trailer, the trailer comprising a frame attached to an axle. One sensor is attached to the frame to detect the roll angle of the frame and a second sensor is attached to the axle to detect the roll angle of the axle. The difference between these two roll angles is utilised to determine the angle between the frame and the axle and thereby calculate the roll moment of the vehicle. A display is then used to indicate to the operator if the roll moment is sufficient such that the vehicle may roll over.

Articulated work machines may also comprise a member such as a body for holding material which can be tipped about a pivot point to empty any material held therein. When the body is tipped, the centre of gravity of the frame to which the body is attached may be raised further from the ground. As a result, the threshold values of the roll and/or yaw angles at which the frame tips over may change, and the frame may be more prone to tipping over.

U.S. Pat. No. 5,742,228 discloses a system for detecting the roll and pitch of a tipper truck which comprises a tipper body. One or more level sensors, such as clinometers, are attached to the tipper body. The sensors detect the lateral level (i.e. roll angle) of the tipper truck and the longitudinal level (i.e. pitch angle) of the tipper body. A processor utilises the outputs of the one or more sensors to determine the risk of the tipper truck overturning and then display such a risk to an operator.

However, U.S. Pat. No. 5,742,228 and U.S. Pat. No. 5,825,284 do not disclose a means by which the orientation of one frame of an articulated work machine can be determined in relation to the other frame.

### SUMMARY

The disclosure therefore provides an articulated work machine comprising; a first frame; a second frame comprising a body and a chassis, the body pivotally connected to the chassis; the first and second frames being connected by a coupling and being movable relative to each other in at least one direction; a first multi-axis inertia sensor attached to the first frame providing an output relating to the position of the first frame; a second multi-axis inertia sensor attached to the body providing an output relating to the position of the body; and a controller which compares the outputs of the first and second multi-axis inertia sensors to calculate the position of the body and the first frame relative to each other.

The disclosure also provides a method of determining the relative position of members of an articulated work machine, the articulated work machine comprising; a first frame to which a first multi-axis inertia sensor is attached; a second frame comprising a body and a chassis, the body pivotally connected to the chassis; a second multi-axis inertia sensor being attached to the body; the first and second frames being connected by a coupling and being movable relative to each other in at least one direction; the method comprising the steps of: comparing the outputs of the first and second multi-axis inertia sensors to calculate the position of the body and the first frame relative to each other.

By way of example only, embodiments of an apparatus and method for the detection of the orientation of the frames of an articulated work machine are now described with reference to, and as shown in, the accompanying drawings.

### BRIEF DESCRIPTION OF THE DRAWINGS

FIG. 1 is a side elevation of one embodiment of an articulated work machine of the present disclosure;

FIGS. 2 to 9 illustrate the pitch and roll angles of the first and second frames of the articulated work machine; and

FIG. 10 is flow diagram illustrating the decision steps of the warning system.

### DETAILED DESCRIPTION

The present disclosure is generally directed towards an apparatus and method for determining the orientation of at least two members of an articulated work machine and their orientation relative to each other. Inertia sensors are attached to two members of the articulated work machine and the output of each inertia sensor is referenced to either the output of the other inertia sensor or a calibrated position parameter, to calculate the orientation of each member in reference to the orientation of the other member.

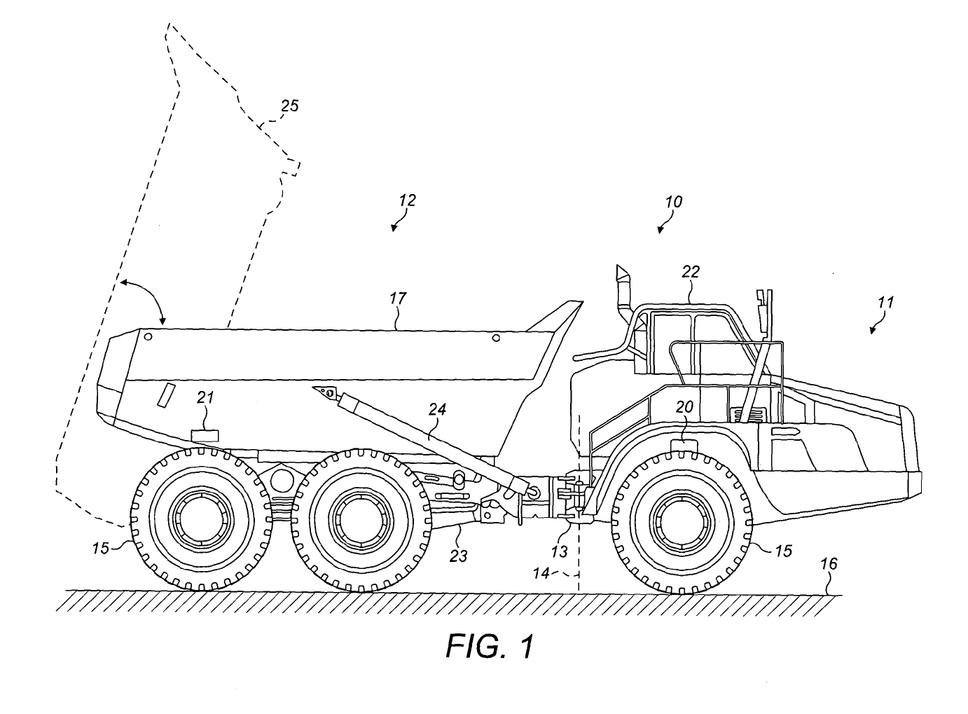

FIG. 1 illustrates an embodiment of an articulated work machine 10 of the present disclosure. Although the illustrated articulated work machine 10 is an articulated tipper truck, the articulated work machine 10 may be any type of articulated work machine. The articulated work machine 10 comprises a first frame 11 in the form of a tractor unit, attached to a second frame 12, in the form of a trailer unit, by a coupling 13.

The coupling 13, which may be an articulation joint, may allow each of the frames 11, 12 to be orientated at a different yaw and/or roll angle to the other frame 12, 11. The yaw angle of the first frame 11 may be different to the yaw angle of the second frame 12 about an axis of articulation 14. The articulated work machine 10 may be steered by adjusting the yaw angle of the first and second frames about the axis of articulation 14 utilising actuators, for example hydraulic cylinders, suitably attached to each of the frames 11, 12 on either side of the coupling 13.

The articulated work machine 10 may further comprise driving means. The driving means comprise ground engaging means 15 in contact with ground 16. The ground engaging means 15 may be, for example, tracks and/or wheels which enable the machine 10 to move along the ground 16, and the articulated work machine 10 may comprise any number of ground engaging means 15. The driving means may further comprise a power unit (not shown) which drives at least one of the ground engaging means 15 to move the articulated work machine 10 along the ground 16. The power unit may be of any suitable type, such as an internal combustion engine, a micro-turbine or an electric motor. In one embodiment, the power unit is situated in/on one of the frames 11, 12 and the coupling 13 transfers power from the power unit to ground engaging means 15 attached to the other frame 12, 11. Therefore, the ground engaging means 15 is/are operably connected to, i.e. receives power from, the power unit. In a further embodiment, all of the ground engaging means 15 of the articulated work machine 10 are operably connected to the power unit.

The second frame 12 may comprise a member, such as an dump(or ejector) body 17 adapted to carry a load. and which is pivotally attached to a chassis 23 at a pivot point. The second frame 12 comprises a tipping system 24 which, when activated, causes the body 17 to rotate about the pivot from a “body down” position into a “body up” position 25, which is a tipping position with one end of the body 17 raised upwardly from the chassis 23 and the other end of the body 17 lowered relative to the chassis 23. The tipping system 24 may be any suitable system, such as, for example, a hydraulic system with one or more hydraulic actuators connected between the body 17 and the chassis 23, a mechanical system or an electric system. As the tipping system 24 rotates the body 17 to the body up position 25, the body 17 ejects any materials or load from the body 17. The body 17 may be any type of container and may be open at the top, fully enclosed or partially enclosed. The body 17 may comprise a gate or door which opens to allow the load or material to be tipped out as the body 17 is rotated into the tipping position 25.

One frame, for example the first frame 11 as illustrated in FIG. 1, may comprise an operator cabin 22 housing the controls for the machine 10.

The articulated work machine 10 further comprises a first multi-axis inertia sensor 20 attached to the first frame 11 and a second multi-axis inertia sensor 21 attached to the body 17 mounted on the second frame 12. The sensor 20 may be attached to any part of the first frame 11 and this acts as the reference sensor. In the illustrated embodiment the second multi-axis inertia sensor 21 may be attached close to the pivoting point between the body 17 and the chassis 23. This enables the length of any wiring leading to the second multi-axis inertia sensor 21 from the chassis 23 to be reduced.

The sensors 20, 21, may be any type of sensor which is capable of determining the pitch, yaw and/or roll angle of the members (i.e. first frame 11 and body 17 in the illustrated example), on which the sensor is positioned relative to the direction of gravitational acceleration. Each of the sensors 20, 21, may be, for example, an inclination sensor, an accelerometer or a gyroscope, and may be of any type, for example, piezoelectric, capacitive, potentiometric, Hall effect, magnetoresistive, piezoresistive or any type of microelectromechanical system (MEMS).

These sensors generally comprise a “proof” mass. This mass moves relative to the frame of the sensor. That difference in movement between the frame and proof mass is related to its acceleration and can be measured in a variety of ways: capacitively, piezo-electrically, and piezo-resistively. A solid object's movement can be fully described by measuring linear acceleration in the x, y, and z directions and angular velocity about the x, y, and z axes.

The work machine 10 further comprises an electronic controller (commonly known as an electronic control module or ECM) which controls various aspect of the work machine 10. The output signals from the sensors 20, 21 are transmitted to the controller and used to calculate relative angles of the members to which the sensors 20,21 are attached, e.g. the angle of the body 17 relative to the first frame 11. The calculations may relate to both fore and aft angles (in the lateral direction of the machine 10) and side to side (across the transverse direction of the machine 10). This is described in more detail below.

In order for the load or materials to be ejected from the body 17 it may not be designed to move relative to the chassis 23, but may instead utilise an ejector mechanism. Ejector mechanisms are well known in the art, and typically comprise an ejector plate which slides horizontally from one end of the inside of the body 17 towards the other end (the ejection end) to push any load or materials out of the body 17. A hydraulic actuator or the like may be used to move the ejector plate towards the ejection end of the body 17.

In such an embodiment the first multi-axis inertia sensor 20 is again positioned on the first frame 11 and the second multi-axis inertia sensor 21 is attached to the body 17.

### INDUSTRIAL APPLICABILITY

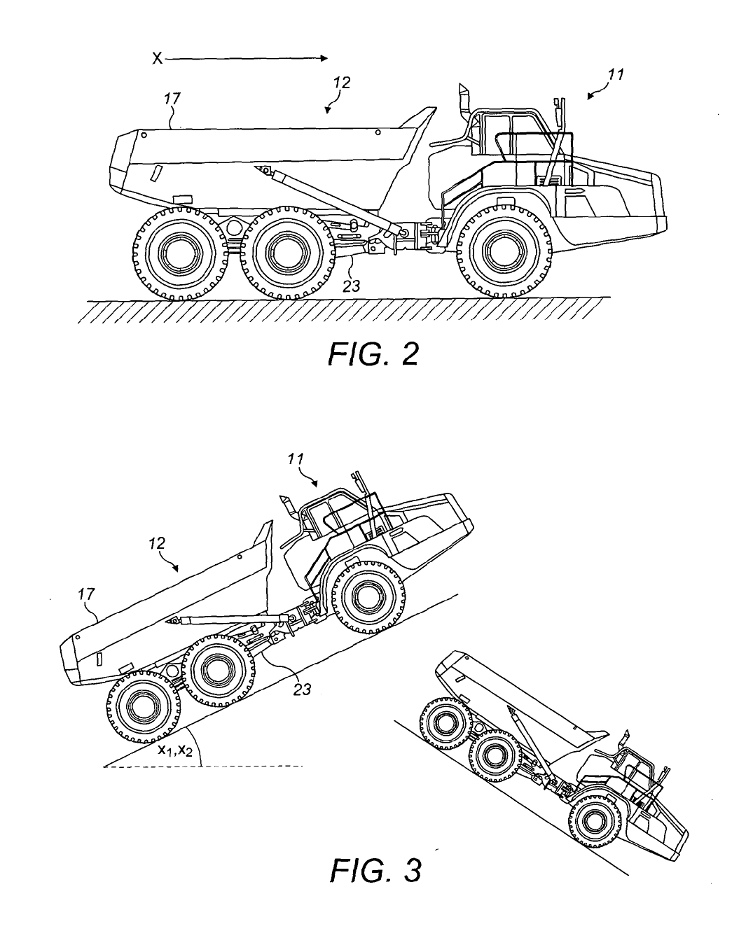

FIGS. 2 to 9 illustrate some possible orientations of a work machine 10 and the relative angles of the first member (in this case the tractor (which forms the first frame 11) and the second member (in this case the body 17 mounted on the trailer chassis 23 of the second frame 12) using the embodiment of FIG. 1. Essentially the relative body angle of the body 17 to the tractor is the absolute angle minus the tractor angle. This applies to both the pitch and the roll angles.

FIG. 2—the body 17 is in the body down position on the chassis 23 and the tractor and trailer 11,12 are in horizontal lateral alignment (i.e from one end of the tractor 11 to the opposing end of the trailer 12, which is shown by the arrow x). The relative body pitch angle (x₁=tractor pitch angle (x₂)=0° as the absolute body angle (x₃) is 0°.

FIG. 3—the body 17 is in the body down position and the tractor and trailer 11,12 are in lateral alignment, but at an angle to the horizontal in the x direction, so the relative body pitch angle (x₁)=tractor pitch angle (x₂) as the absolute body angle (x₃) is 0°.

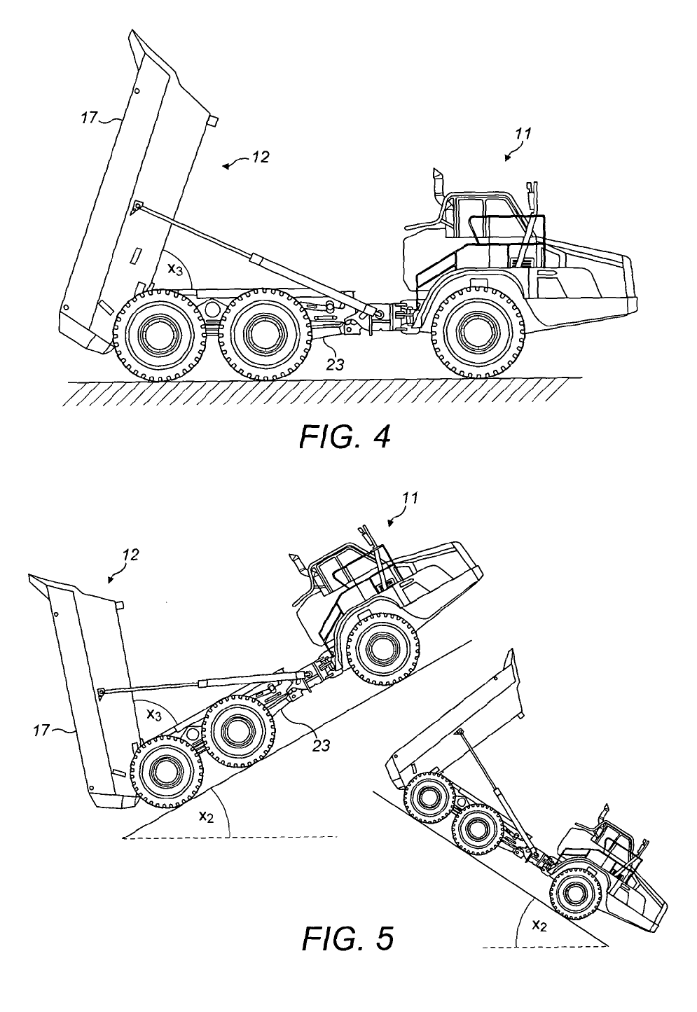

FIG. 4—the body 17 is in the body up position and the tractor and trailer 11,12 are in horizontal lateral alignment, so the relative body pitch angle (x₁)=absolute body angle (x₃)−tractor pitch angle (x₂);

FIG. 5—the body 17 is in the body up position and the tractor and trailer 11,12 are in lateral alignment at an angle to the horizontal, so the relative body pitch angle (x₁)=absolute body angle (x₃)−tractor pitch angle (x₂);

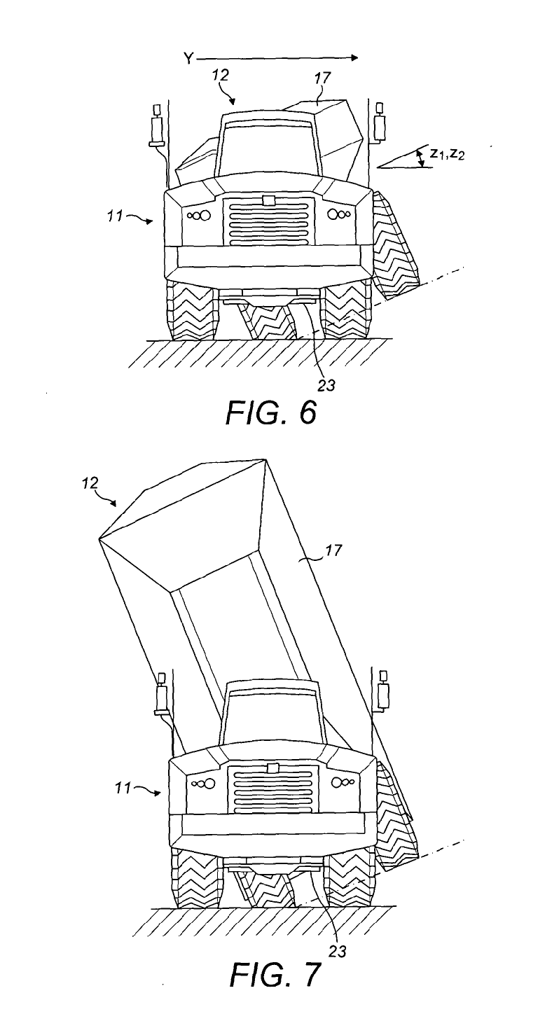

FIG. 6—the body 17 is in the body down position and the tractor and trailer 11,12 are in horizontal transverse alignment (i.e. from one side of the tractor and trailer 11,12 to the opposing side which is shown by the arrow y) and horizontal lateral alignment, so the relative body pitch angle (x₁)=tractor pitch angle (x₂) as the absolute body angle (x₃) is 0°. However the body 17 is tilted sideways relative to the frame 11, so the relative body roll angle (z₁=absolute body angle (z₃) as the tractor roll angle (z₂) is 0°;

FIG. 7—the body 17 is in the body up position and is in lateral alignment with the trailer 23 so the body pitch angle (x₁)=body angle (x₃)−first frame pitch angle (x₂). However the trailer 23 is also tilted sideways relative to the tractor 11, so the relative body roll angle (z₁)=absolute body angle (z₃) as the tractor roll angle (z₂) is 0°.

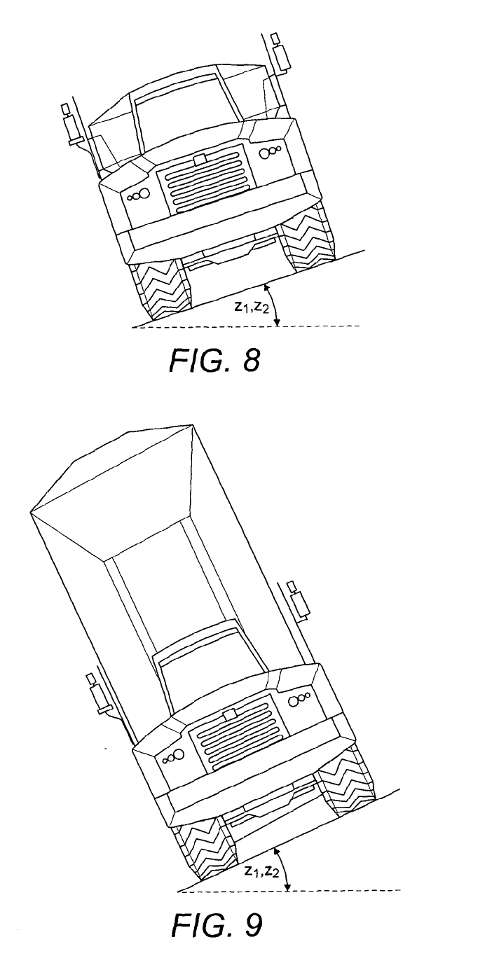

FIG. 8—the body 17 is in the body down position and the tractor and trailer 11,12 are in lateral and transverse alignment, although the whole machine 10 is on a side slope, at an angle to the horizontal in the y direction, so the relative body pitch angle (x₁)=tractor pitch angle (x₂) as the absolute body pitch angle (x₃) is 0°. The relative body roll angle (z₁) is 0° as the absolute body roll angle (z₃) is the same as the tractor roll angle (z₂).

FIG. 9—the body 17 is in the body up position and the tractor and trailer 11,12 are in horizontal and lateral alignment, although the whole machine 10 is on a side slope, at an angle to the horizontal in the y direction so the relative body pitch angle (x₁)=body angle (x₃)−first frame pitch angle (x₂). The tractor 11, body 17 and the chassis 23 are all tilted at the same angle in the y direction, so the relative body roll angle (z₁) is 0° as the absolute body roll angle (z₃) is the same as the tractor roll angle (z₂).

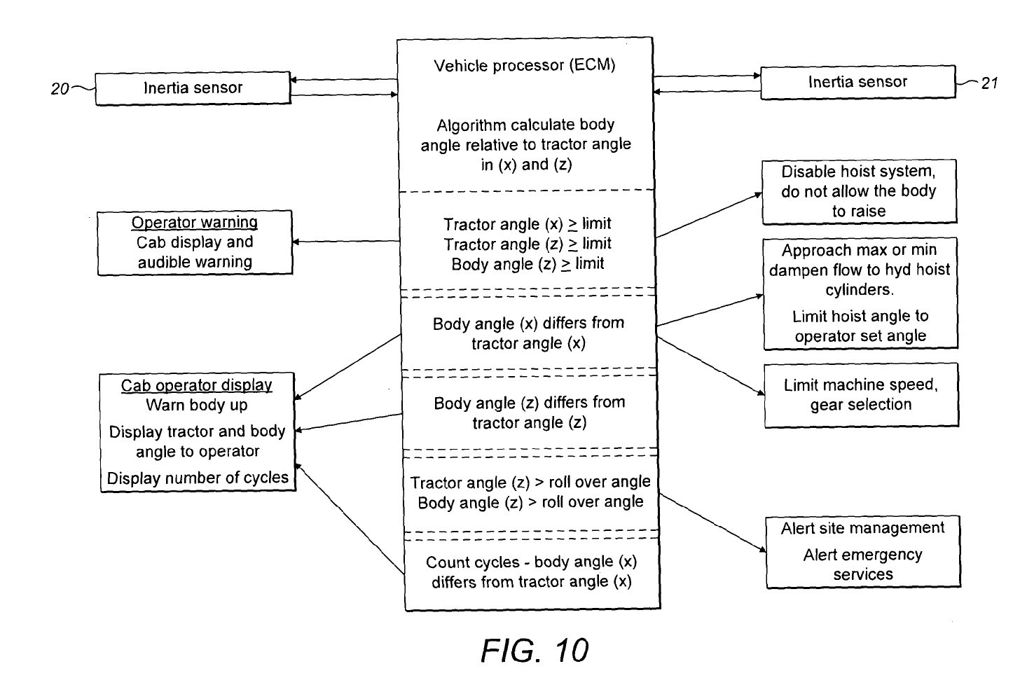

This angle information may be utilized by the controller in an algorithm, which allows the operator and manufacturer to set safety limits for the various angles. FIG. 10 illustrates the decision steps which may be made by such an algorithm. Once the individual positions (angles) of the two members on which the sensors 20, 21 are mounted have been determined, the controller is able to calculate the relative angles between them. The calculation may be achieved by comparing the outputs of the two sensors 20,21 with each other, or with a calibrated position parameter. The actual and relative angles may then be compared to the preset limits for the various angles. In the event that certain of the preset limits are exceeded the controller may be programmed to disable the tipping system 24, to limit the body angle (x₃) to which the body 17 can be tipped, limit the machine speed or gear selection, provide a warning or display or an emergency alert. These may include:
Body up
Body raise angle
The number of cycles in which the measured angles differ from each other in a defined time interval
Relative angles of the first and second members with a warning of potential roll over if any of the angles exceed the preset limits
Relative angles of the first and second members with a warning that the machine 10 is operating/tipping at an unsafe angle, for example on an unsafe side slope

This information can thus be utilized by the controller to:
Reduce frame impact stresses by automatically reducing cylinder pressure/flow when the body 17 is approaching the down position
Reduce cylinder stresses by automatically reducing cylinder flow when the body 17 is approaching the fully raised position
Notify, via a suitable machine communication system, site management or the emergency services that a machine 10, or either member 11 or 17 has rolled.

The apparatus and method of detecting the state of an articulated work machine can be used in a wide variety of work machines, which have articulated frames (tractor or trailer) and a member mounted on at least one of the frames (body) which can move relative to each other.

The use of multi-axis inertia sensors 20,21 allows for enhanced functionality over the prior art, i.e. roll over warning, warning against operating tipping on an unsafe side slop, and further provides installation, reliability and durability benefits. In particular the system provides improved information for the operator and improved safety.

1. An articulated work machine comprising;
a first frame;
a second frame comprising a body and a chassis, the body pivotally connected to the chassis at a pivot point;
the first and second frames being connected by a coupling and being movable relative to each other in at least one direction;
a first multi-axis inertia sensor attached to the first frame providing an output relating to the position of the first frame;
a second multi-axis inertia sensor attached to the body providing an output relating to the position of the body; and
a controller configured to compare the outputs of the first and second multi-axis inertia sensors to calculate the position of the body and the first frame relative to each other.

2. The articulated work machine of claim 1, wherein the second frame further includes a member for raising the body off the chassis about the pivot point to a tipping angle.

3. The articulated work machine of claim 2, wherein the member includes a hydraulic system.

4. The articulated work machine of claim 1, wherein the first and second frames are movable relative to each other so as to be orientated at one or more of a different pitch or roll angle to each other.

5. The articulated work machine of claim 1, wherein at least one of the first and second multi-axis inertia sensors is an inclination sensor.

6. The articulated work machine of claim 4, wherein the first and second multi-axis inertia sensors measure at least one of an absolute pitch and an absolute roll angle of the frame to which it is attached.

7. The articulated work machine of claim 6, wherein the controller is further configured to calculate at least one of a relative pitch angle and a relative roll angle of the frames, the relative pitch and relative roll angles being relative to at least one of the absolute pitch and the absolute roll angles respectively.

8. The articulated work machine of claim 7, wherein the controller is further configured to compare the relative and the absolute pitch and roll angles with one or more preset limits.

9. A method of determining the relative position of members of an articulated work machine, the articulated work machine comprising;
a first frame having a first and a second multi-axis inertia sensor;
a second frame comprising having a body and a chassis, the body pivotally connected to the chassis;
the first and second frames being connected by a coupling and being movable relative to each other in at least one direction; and
a controller in communication with the first and second multi-axis inertia sensors;
the method comprising the steps of:
comparing, by the controller, the outputs of the first and second multi-axis inertia sensors; and
calculating, by the controller, the position of the body and the first frame relative to each other based on the comparison.

10. The method of claim 9 further including measuring at least one of an absolute pitch angle and an absolute roll angle of the first and second frames using the first and second multi-axis inertia sensors.

11. The method of claim 10 further including calculating, by the controller, at least one of a relative pitch and a relative roll angle of the frames relative to one or more of the absolute pitch and the absolute roll angles respectively.

12. The method of claim 11 further including comparing, by the controller, the absolute and the relative angles with one or more preset limits.

13. The method of claim 12 further including storing, by the controller, information indicative of a number of cycles in which the absolute angle of the first frame differs from the absolute angle of the second frame over a predetermined time period.

14. The method of claim 12 further including providing, by the controller, a warning signal to an operator of the machine when any of the relative or the absolute angles exceeds at least one of the preset limits.

15. The method of claim 12 further including modifying, by the controller, the operation of the machine when any of the relative or the absolute angles exceeds at least one of the preset limits.

16. The method of claim 15 further including raising, by a hydraulic member attached to the second frame of the machine, the body off the chassis about the pivot point, wherein modifying the operation of the machine includes one or more of disabling the hydraulic member, restricting the hydraulic member from raising the body off of the chassis beyond a predetermined hoist angle, limiting a machine speed, and limiting a machine gear selection.

17. The method of claim 12 further including providing, by the controller, an emergency alert to an emergency service provider when any of the relative or the absolute angles exceeds at least one of the preset limits.

18. An articulated work machine comprising;
a first frame;
a second frame comprising a body and a chassis, the body pivotally connected to the chassis at a pivot point;
the first and second frames being connected by a coupling and being movable relative to each other so as to be oriented at one or more of a different pitch or roll angle to each other;
a hydraulic member for raising the body off the chassis about the pivot point to a tipping angle;
a first multi-axis inertia sensor attached to the first frame providing an output relating to the position of the first frame;
a second multi-axis inertia sensor attached to the body providing an output relating to the position of the body, wherein the first and second multi-axis inertia sensors measure at least one of an absolute pitch and an absolute roll angle of the frame to which it is attached; and
a controller configured to:
compare the outputs of the first and second multi-axis inertia sensors to calculate at least one of a relative pitch angle and a relative roll angle of the frames, the relative pitch and relative roll angles being relative to at least one of the absolute pitch and the absolute roll angles respectively;
compare the relative and the absolute pitch and roll angles with one or more preset limits; and
modify operation of the machine when any of the relative or the absolute angles exceeds at least one of the preset limits.

19. The articulated work machine of claim 18, wherein:
the second frame further includes a hydraulic member for raising the body off the chassis about the pivot point to a tipping angle; and
the controller is further configured to modify operation of the machine by one or more of disabling the hydraulic member, restricting the hydraulic member from raising the body off of the chassis beyond a predetermined hoist angle, limiting a machine speed, and limiting a machine gear selection.

20. The articulated work machine of claim 18 further including an alert system, wherein the controller directs the alert system to provide a warning signal to one or more of an operator of the machine and an emergency service provider when any of the relative or the absolute angles exceeds at least one of the preset limits.
